(19) United States
(12) Patent Application Publication
(10) Pub. No.: US 2016/0292616 A1
(43) Pub. Date: Oct. 6, 2016

(54) SUPPORT PERSON SELECTION DEVICE, SUPPORT PERSON SELECTION METHOD, AND COMPUTER-READABLE RECORDING MEDIUM

(71) Applicant: NEC SOLUTION INNOVATORS, LTD., Koto-ku, Tokyo (JP)

(72) Inventor: Kazuki HIROZAWA, Tokyo (JP)

(73) Assignee: NEC Solution Innovators, Ltd., Tokyo (JP)

(21) Appl. No.: 15/037,253

(22) PCT Filed: Nov. 4, 2014
(86) PCT No.: PCT/JP2014/079216

§ 371 Date: May 17, 2016

(30) Foreign Application Priority Data
Nov. 19, 2013 (JP) 2013-239083

(51) Int. Cl. G06Q 10/06; G06F 17/30

(52) U.S. Cl. CPC G06Q 10/063112; G06Q 10/06398; G06F 17/30424

(57) ABSTRACT

A support person selection device (10) selects a support person who is to provide support that a user seeks. The support person selection device (10) includes a support person candidate extraction unit (11) for extracting at least one support person candidate who can provide the support that the user seeks, based on a schedule of the support person which is registered in advance and a condition that the user seeks, a most suitable support person selection unit (12) for selecting, from the at least one support person candidate, a support person to whom a request for the support is to be made, based on evaluation information associated with each support person, and an evaluation information registration unit (13) for receiving evaluation made by the user who has received the support from the selected support person, and updating the evaluation information associated with the selected support person or creating new evaluation information.

### TECHNICAL FIELD

The present invention relates to a support person selection device and a support person selection method for automatically selecting a support person who is to provide support that a user seeks, particularly a note-taker in the case where a user seeks note-taking, and a computer-readable recording medium storing a program for achieving the device and the method.

### BACKGROUND ART

A person with hearing impairment whose hearing level of both ears is minus 100 dB or less (hereinafter referred to simply as “a person with hearing impairment”) can hardly receive language information in the sound even with hearing aids or the like. For this reason, conventionally, support by a sign language interpreter or support by a note-taker needs to be provided in the case where a person with hearing impairment attends a lecture, a class at school, or the like.

Here, the support by a note-taker is described. For example, in the case of providing support by a note-taker in a class at school, two or more note-takers form a team to provide the support to a student with hearing impairment. In this case, the note-takers are seated next to each other, write down the content of a speech of a teacher or the like using PCs (Personal Computers), paper notebooks, or the like, and present the written content to the student with hearing impairment.

In order to achieve such support by the note-takers, the presence of a coordinator is important, who mediates between a person with hearing impairment and the note-takers to form a team and adjust the schedule of each note-taker, for example. Specifically, the coordinator receives requests for note-taking support from those with hearing impairment and manages each request in a timetable or the like. The coordinator also adjusts the schedule of note-takers and forms a team for each request for note-taking support, using emails or telephone.

However, as mentioned above, an operation of forming a team of two or more note-takers is a troublesome operation that requires schedule adjustment for a plurality of persons. In addition, each person with hearing impairment has preferences regarding the accuracy and the speed of character input of note-takers, and the coordinator also needs to consider such preferences. For this reason, an operation of forming a team of two or more note-takers places the greatest burden on the coordinator, and a system capable of automatically forming a team is desired.

In companies or the like, since operations that can be processed by an individual are limited due to a recent advance of work, a plurality of persons cooperate to carry out a series of operations. Therefore, in general, a team is formed and the work is carried out by the team. For this reason, conventionally, devices and systems that enable automatic team-forming have been proposed (e.g., see Patent Documents 1 to 3).

For example, Patent Document 1 discloses a device that assists team-forming, while considering a relationship between workers. In the device disclosed in Patent Document 1, team evaluation information that is based on an operation result and mutual evaluation information that specifies mutual evaluations among workers are created for each team that has carried out an operation in the past, and a team is formed based on this information.

Patent Document 2 discloses a device that efficiently determines team members who are suitable for a project. In the device disclosed in Patent Document 2, initially, when determining team members (personnel) for executing a current project, a past project that is similar to the current project is specified. Next, in this device, information about team members who participated in the specified past project is acquired, and furthermore, team members suitable for the current project are determined based on the acquired information.

Furthermore, Patent Document 3 discloses a system that provides interpretation services via a network. In the system disclosed in Patent Document 3, initially, the demand for interpretation is predicted, and employees (team members) who are to perform interpretation are selected based on this prediction in order from an employee with a higher evaluation score in overall evaluation score data, while taking workability conditions into consideration. Note that the evaluation score is preset from the viewpoints of basic academic skill evaluation, vocabulary evaluation, general common sense evaluation, simultaneous interpretation level evaluation, and the like.

### LIST OF PRIOR ART DOCUMENTS

### Patent Document

Patent Document 1: JP 2001-282965A

Patent Document 2: JP 2007-026404A

Patent Document 3: JP 2003-036304A

### DISCLOSURE OF THE INVENTION

### Problems to be Solved by the Invention

Thus, it is conceivable that use of the devices and systems described in Patent Documents 1 to 3 facilitates the team-forming in companies or the like. However, the systems and the devices disclosed in Patent Documents 1 to 3 are not suitable for forming a team of note-takers for the following reasons, and even if these are used, it is difficult to reduce the burden on the coordinator.

Firstly, the devices disclosed in Patent Documents 1 and 2 are aimed at team-forming in a long-term project, and are not aimed at team-forming in a short-term project. For this reason, with these devices, it is difficult to form a team for every time at which a person with hearing impairment makes a request for note-taking support, and these devices are not suitable for forming a team of note-takers.

In addition, with the devices disclosed in Patent Documents 1 and 2, it is also difficult to reflect the aforementioned preferences of each person with hearing impairment in team-forming, and these devices are not suitable for forming a team of note-takers either in this regard.

Meanwhile, the system disclosed in Patent Document 3 can select as many interpreters as necessary at the necessary time, and it is conceivable that, with this system, a short-term team of note-takers can be formed.

However, as for the system disclosed in Patent Document 3, interpreters who are constituent members of a team are employees who belong to a single company, and the management side can determine the schedule of each interpreter, which makes it possible to form a short-term team. For this reason, considering the point that many note-takers are freelances, even the system disclosed in Patent Document 3 is not suitable for forming a team of note-takers either.

Furthermore, the system disclosed in Patent Document 3 is not configured such that evaluation made by a person for whom interpretation was performed is fed back to an evaluation score used in the selection of an interpreter, and the evaluation score is set on the management side in the system. Accordingly, even with the system disclosed in Patent Document 3, it is difficult to reflect the aforementioned preferences of a person with hearing impairment in the team-forming.

### Object of the Invention

As described above, an exemplary object of the present invention is to provide a support person selection device, a support person selection method, and a computer-readable recording medium with which it is possible to solve the foregoing problems, deal with a short-term support, and reflect a user evaluation in selection of a support person who is to provide support to the user.

### Means for Solving the Problems

To achieve the above-stated object, a support person selection device according to an aspect of the present invention is a device for selecting a support person who is to provide support that a user seeks, including:

a support person candidate extraction unit for extracting at least one support person candidate who can provide the support that the user seeks, based on a schedule of the support person which is registered in advance and a condition that the user seeks;

a most suitable support person selection unit for selecting, from the at least one extracted support person candidate, a support person to whom a request for the support is to be made, based on evaluation information associated with each support person; and

an evaluation information registration unit for receiving evaluation made by the user who has received the support from the selected support person, and updating the evaluation information associated with the selected support person or creating new evaluation information.

Also, to achieve the above-stated object, a support person selection method according to an aspect of the present invention is a method for selecting a support person who is to provide support that a user seeks, the method including:

a step (a) of extracting at least one support person candidate who can provide the support that the user seeks, based on a schedule of the support person which is registered in advance and a condition that the user seeks;

a step (b) of selecting, from the at least one extracted support person candidate, a support person to whom a request for the support is to be made, based on evaluation information associated with each support person; and

a step (c) of receiving evaluation made by the user who has received the support from the selected support person, and updating the evaluation information associated with the selected support person or creating new evaluation information.

Furthermore, to achieve the above-stated object, a computer-readable recording medium according to an aspect of the present invention is a computer-readable recording medium that stores a program for selecting a support person who is to provide support that a user seeks, by a computer, the recording medium storing a program including a command for causing the computer to execute:

a step (a) of extracting at least one support person candidate who can provide the support that the user seeks, based on a schedule of the support person which is registered in advance and a condition that the user seeks;

a step (b) of selecting, from the at least one extracted support person candidate, a support person to whom a request for the support is to be made, based on evaluation information associated with each support person; and

a step (c) of receiving evaluation made by the user who has received the support from the selected support person, and updating the evaluation information associated with the selected support person or creating new evaluation information.

### Advantageous Effects of the Invention

As described above, according to the present invention, it is possible to deal with short-term support and reflect a user evaluation in selection of a support person who is to provide support to the user.

### BRIEF DESCRIPTION OF THE DRAWINGS

FIG. 1 is a block diagram showing a schematic configuration of a support person selection device according to an embodiment of the present invention.

FIG. 2 is a block diagram showing a specific configuration of the support person selection device according to an embodiment of the present invention.

FIG. 3 is a diagram showing exemplary information that is registered in a support person schedule database shown in FIG. 2.

FIG. 4 is a diagram showing exemplary information that is registered in a support person information database shown in FIG. 2.

FIG. 5 is a diagram showing exemplary information that is registered in an evaluation information database shown in FIG. 2.

FIG. 6 is a flowchart showing operations of the support person selection device according to an embodiment of the present invention.

FIG. 7 is a diagram illustrating a specific example of steps A1 to A3 shown in FIG. 6.

FIG. 8 is a diagram illustrating a specific example of steps A3 and A4 shown in FIG. 6.

FIG. 9 is a block diagram showing an exemplary computer that achieves the support person selection device according to an embodiment of the present invention.

### MODE FOR CARRYING OUT THE INVENTION

### Embodiments

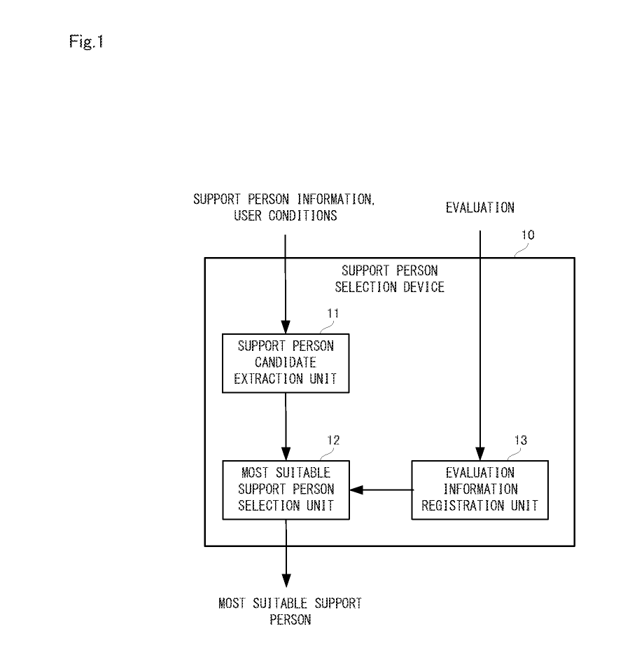

Hereinafter, a support person selection device, a support person selection method, and a program according to an embodiment of the present invention will be described with reference to FIGS. 1 to 9.

[Device Configuration]

Firstly, a configuration of a support person selection device according to an embodiment of the present invention will be described using FIG. 1. FIG. 1 is a block diagram showing a schematic configuration of a support person selection device according to an embodiment of the present invention. A support person selection device 10 shown in FIG. 1 is a device for selecting a support person who is to provide support that a user seeks.

As shown in FIG. 1, the support person selection device 10 includes a support person candidate extraction unit 11, a most suitable support person selection unit 12, and an evaluation information registration unit 13. Of these units, the support person candidate extraction unit 11 extracts at least one support person candidate who can provide support that a user seeks, based on schedules of support persons which are registered in advance and a condition that the user seeks.

The most suitable support person selection unit 12 selects a support person to whom a support request is to be made from among the at least one extracted support person candidate based on evaluation information that is associated with each support person. The evaluation information registration unit 13 receives evaluation made by a user who has received support from the selected support person, and updates the evaluation information that is associated with the selected support person or creates new evaluation information.

Thus, in the support person selection device 10, initially, the support person candidate is extracted based on the schedules of the support person and the condition such as the schedule or the like that the user seeks, and it is accordingly possible to deal with short-term support. In the support person selection device 10, a final support person is selected based on the evaluation information that is created or updated based on a user evaluation, and accordingly, the user evaluation is reflected in the selection of the support person.

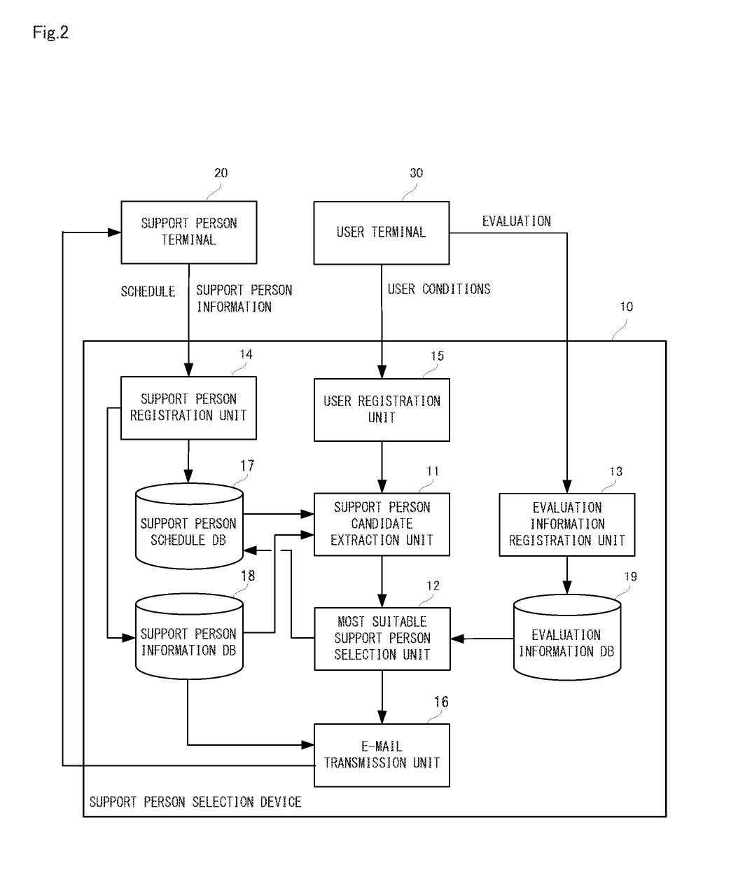

Subsequently, the configuration of the support person selection device according to this embodiment will be more specifically described using FIGS. 2 to 5. FIG. 2 is a block diagram showing a specific configuration of the support person selection device according to the embodiment of the present invention.

Initially, in this embodiment, a user is a person with hearing impairment, and support that the user seeks is note-taking in a class at school. A support person is a note-taker. As shown in FIG. 2, a terminal (hereinafter referred to as an “support person terminal”) 20 used by the support person and a terminal (hereinafter referred to as a “user terminal”) 30 used by the user are connected to the support person selection device 10 via a network or the like.

In this embodiment, as shown in FIG. 2, the support person selection device 10 includes a support person registration unit 14, a user registration unit 15, and an e-mail transmission unit 16 in addition to the aforementioned support person candidate extraction unit 11, most suitable support person selection unit 12, and evaluation information registration unit 13. The support person selection device 10 also includes, as databases (hereinafter referred to simply as “DBs”), a support person schedule DB 17, a support person information DB 18, and an evaluation information DB 19.

The support person registration unit 14 receives a schedule of a support person from the support person terminal 20, and registers the received schedule in the support person schedule DB 17. The support person registration unit 14 also receives support person information as well as the schedule, and registers the received support person information in the support person information DB 18. In this embodiment, the support person information includes the type of knowledge that the support person has, and an e-mail address of the support person.

Note that, in the example in FIG. 2, the support person registers his/her schedule and support person information by himself/herself using the support person terminal 20. However, this embodiment is not limited thereto. For example, a coordinator who knows the schedule of each support person may register the schedule and the support person information using a terminal.

The support person registration unit 14 can not only register information in each DB but also correct and delete the information in accordance with an instruction given by a support person or the like. Furthermore, in the case where an ID and a password are assigned in advance to each support person in order to avoid alteration by a third party, the support person registration unit 14 can also perform authentication processing. In this case, the support person registration unit 14 accepts registration, deletion, and correction of the schedule and the support person information under a condition that authentication is successful.

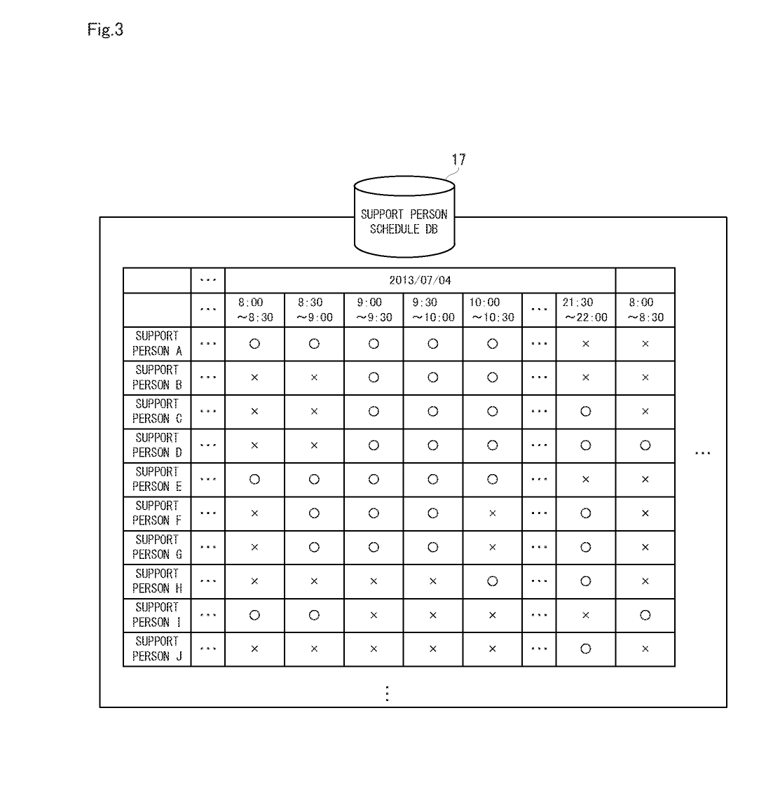

FIG. 3 is a diagram showing exemplary information registered in a support person schedule database shown in FIG. 2. As shown in FIG. 3, in this embodiment, a schedule of each support person, i.e., dates and time periods in which each support person can provide support are stored in the support person schedule DB 17. In the example in FIG. 3, time periods that can be selected by the support persons are set from 8:00 in the morning, which is considered to be the class start time, to 22:00 that is the class end time at intervals of 30 minutes. In the example in FIG. 3, “O” is shown in a time period in which each support person can provide support, and “X” is shown in a time period in which each support person cannot provide support.

In this embodiment, the schedules registered in the support person schedule DB 17 are not limited to the example in FIG. 3, and for example, the time periods may be set at intervals of 15 minutes or may be set at intervals of an hour as long as the time intervals are consistent among the support persons. The first and last time periods that can be set are not limited either, and in the case where night classes are held, the end time may be at 22:00 or later. Furthermore, the time periods may be set in 24 hours.

If the support person registration unit 14 is given a request to register a schedule, the support person registration unit 14 can also display a calendar on a screen of the support person terminal 20 and have a support person select a date on which the support person can provide support and a time period in which the support person can provide support. In this case, the support person registration unit 14 registers, for each support person, the selected date and time period in the support person schedule DB 17.

Furthermore, if the support person registration unit 14 is given a request to correct or delete a schedule, the support person registration unit 14 can display a calendar in which registered content is reflected on the screen of the support person terminal 20. Upon an instruction of correction or deletion being given on the calendar, the support person registration unit 14 updates the support person schedule DB 17 based on the content of the instruction.

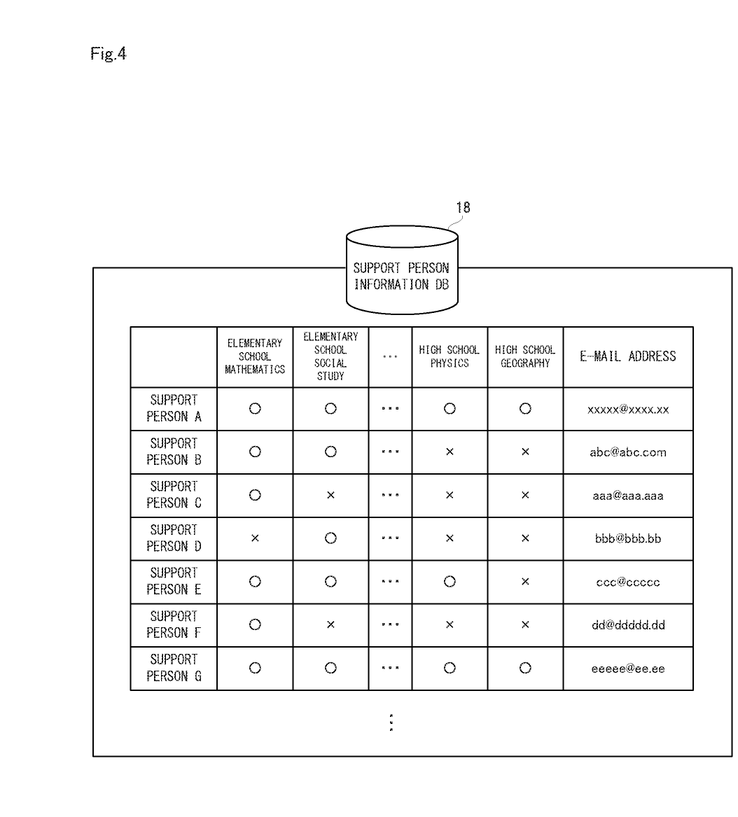

FIG. 4 is a diagram showing exemplary information registered in the support person information database shown in FIG. 2. As shown in FIG. 4, in this embodiment, support person information, i.e., the type of knowledge that each support person has and an e-mail address of each support person are stored in the support person information DB 18. The e-mail address registered in the support person information DB 18 is used for transmission of an e-mail by the later-described e-mail transmission unit 16.

In the example in FIG. 4, the “type of knowledge that each support person has” is expressed by a subject title (e.g., a subject of study from elementary school level to high school level) for which each support person can carry out note-taking. It is understood from the example in FIG. 4 that a support person A has knowledge necessary for carrying out note-taking in a high school physics class, whereas a support person B does not have the knowledge thereof and therefore cannot carry out note-taking in a high school physics class.

The support person registration unit 14 can also newly add or delete a subject for which support persons can carry out note-taking in the support person information DB 18. Furthermore, in this embodiment, the subjects registered in the support person information DB 18 are not limited to the subjects of study from elementary school level to high school level, and may also be subjects of study of university level, subjects for a qualification examination, or the like.

Furthermore, this embodiment may employ a mode of having a support person take an examination of each subject in advance and transmit the score thereof to the support person selection device 10 via the support person terminal 20. In this mode, the support person registration unit 14 compares a result of the examination of each subject with the minimum requisite score for the subject, and registers only a subject for which the support person has gained the minimum score or more as a subject that this support person can carry out note-taking in the support person information DB 18.

The user registration unit 15 also receives conditions that a user seeks (hereinafter referred to as “user conditions”) from the user terminal 30 and registers the received condition. Furthermore, the user registration unit 15 outputs the registered user conditions to the support person candidate extraction unit 11.

In this embodiment, the user conditions include the date on which a class (or a lecture) for which note-taking is to be carried out is held, the start time, the end time, the type of knowledge necessary for the class, and the number of necessary support persons. The user conditions may further include an ID for specifying a user, and a class title.

The “type of knowledge necessary for the class” may be expressed in the same expression form of the “type of knowledge that the support person has” registered in the support person information DB 18. In this embodiment, the “type of knowledge necessary for the class” may be also expressed by the title of a subject of study from elementary school level to high school level.

Furthermore, in the case where an ID and a password are assigned in advance to each user, the user registration unit 15 can also perform authentication processing. In this case, the user registration unit 15 receives the user conditions and registers the received user conditions under a condition that authentication is successful.

In this embodiment, the support person candidate extraction unit 11 extracts a support person candidate by comparing the schedule of each support person registered in the support person schedule DB 17 and the knowledge that each support person has registered in the support person information DB 18 with the user conditions. Specifically, the support person candidate extraction unit 11 specifies a support person who is available on the date and at the time when the class is held and can carry out note-taking for the subject that the user seeks, and extracts the specified support person as a support person candidate. The support person candidate extraction unit 11 also outputs the ID of the support person who is the support person candidate and the user conditions to the most suitable support person selection unit 12.

In this embodiment, the evaluation information registration unit 13 receives, from the user terminal 30, the evaluation made by the user who has received the note-taking support, and registers the received evaluation as the evaluation information in the evaluation information DB 19. The user can also correct the registered evaluation via the user terminal 30.

In this embodiment, the evaluation made by the user is expressed by a numerical value indicating a grade of each of the items such as the input accuracy in note-taking, the input speed, the understandability of a summary note, and impression of the note-taker who has carried out the note-taking. Accordingly, the evaluation information registered in the evaluation information DB 19 also includes the numerical value indicating the grade of each item.

In the case where an ID and a password are assigned in advance to each user, the evaluation information registration unit 13 can also perform authentication processing as the user registration unit 15 does. In this case, the evaluation information registration unit 13 receives the evaluation and registers the evaluation information under a condition that the authentication is successful.

Specifically, when authentication is successful, the user selects a support person who is to be evaluated, evaluates the selected support person based on a five-grade scale by selecting a value from 1 to 5 for each of the aforementioned items, and transmits a result from the user terminal 30. In the evaluation based on the five-grade scale, it is assumed here that “5” indicates the highest evaluation and “1” indicates the lowest evaluation. In the case of correcting the content of the registered evaluation, the user selects correction after the authentication, selects a support person regarding whom the correction is to be made, and corrects the displayed value of each item. The grades of the evaluation are not particularly limited, and need only be consistent among users. The evaluation may be made by scores rather than the numerical values indicating the grades.

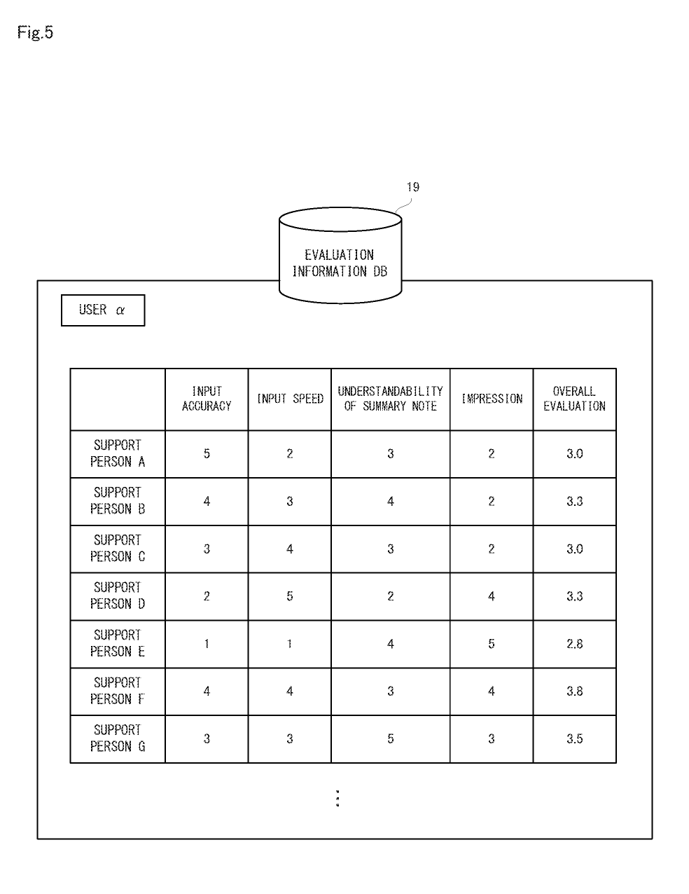

FIG. 5 is a diagram showing exemplary information registered in the evaluation information database shown in FIG. 2. As shown in FIG. 5, in this embodiment, the evaluation information includes the evaluations based on the five-grade scale regarding the respective items and an overall evaluation of each support person. The overall evaluation is an average value of all evaluation values. The example in FIG. 5 shows the evaluation information that a user a has made for each support person. The user a evaluates, of the support person A, the input accuracy as “5”, the input speed as “2”, the understandability of the summary note as “3”, and the impression as “2”. The overall evaluation is an average value of these values, and is “3.0”.

The overall evaluation is not limited to the average value, and may be an accumulated value, a largest value, or a smallest value. The overall evaluation need only be consistent among users. The calculation of the overall evaluation may be performed by the most suitable support person selection unit 12. In this case, the value of the overall evaluation does not have to be registered in the evaluation information DB 19.

As shown in FIG. 5, the evaluation information is created for each user, and the evaluation information includes evaluations that a corresponding user has made for each support person. If the evaluation information registration unit 13 receives a new evaluation regarding already-registered evaluation information, the evaluation information registration unit 13 updates this evaluation information. However, if the received evaluation is registration information that has not yet been registered, the evaluation information registration unit 13 creates new registration information and registers this information.

For example, if the received evaluation is evaluation that the user a has made for the support person A, since the evaluation of the support person A has already been registered, the evaluation information registration unit 13 updates the evaluation information. On the other hand, if the received evaluation is evaluation that the user a has made for a support person H, since evaluation of the support person H has not yet been registered, the evaluation information registration unit 13 creates new evaluation information and registers the new evaluation information.

In this embodiment, the most suitable support person selection unit 12 selects as many support persons as necessary from among the support person candidates based on the overall evaluation obtained from the numerical values indicating the grades of the respective items included in the evaluation information in order from a support person candidate with a best overall evaluation result. Note that, in this embodiment, the most suitable support person selection unit 12 may make the overall evaluation of each support person candidate using numerical values indicating the grades of the respective items included in the evaluation information.

Specifically, the most suitable support person selection unit 12 references the evaluation information about the respective support person candidates registered in the evaluation information DB 19, rearranges the support person candidates in order from a support person candidate with a highest overall evaluation, and further selects as many support persons as defined in the user conditions in order from a support person candidate with a highest overall evaluation. The most suitable support person selection unit 12 also outputs the IDs of the selected support persons to the e-mail transmission unit 16 and discards the IDs of the unselected support person candidates.

Furthermore, since the schedules of the selected support persons are filled as a result, the most suitable support person selection unit 12 accesses the support person schedule DB 17 and registers the schedules of the selected support persons in the corresponding time period on the corresponding date that have been filled. Specifically, the most suitable support person selection unit 12 corrects “O” shown in boxes of the corresponding time period on the corresponding date for the selected support persons as “X”.

Note that the most suitable support person selection unit 12 may rearrange the support person candidates while paying attention not to the overall evaluation but only to a specific item, and further select as many support persons as defined in the user information in order from a support person candidate with a highest evaluation on the item to which attention is paid.

The e-mail transmission unit 16 transmits an e-mail for making a request for support (note-taking) that the user seeks to the support persons selected by the most suitable support person selection unit 12. Specifically, the e-mail transmission unit 16 initially acquires an e-mail address of each support person selected by the most suitable support person selection unit 12 from the support person information DB 18. Next, the e-mail transmission unit 16 creates an e-mail indicating the user conditions and that the support person has been registered as a note-taker and transmits this e-mail to the acquired e-mail address. The support persons can thereby be notified that a note-taking request has been made to him/her.

[Device Operations]

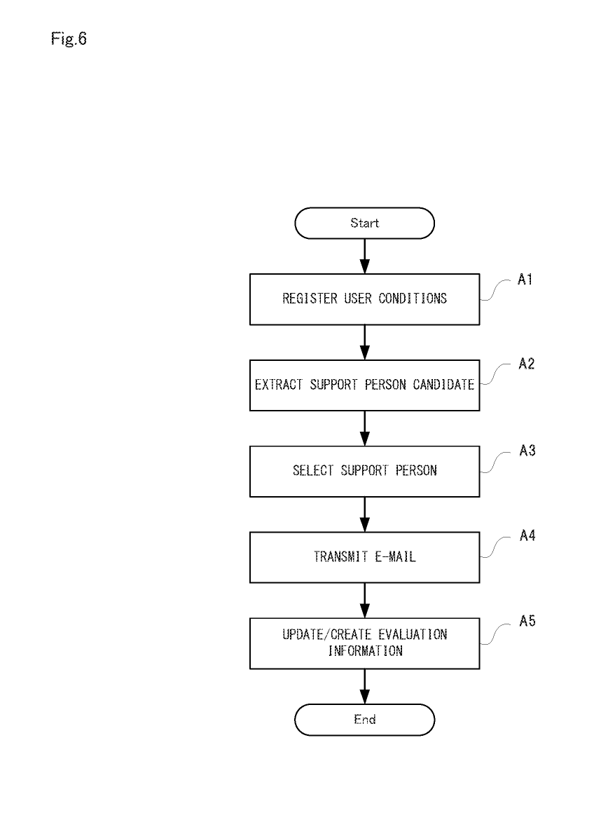

Next, operations of the support person selection device 10 according to the embodiment of the present invention will be described using FIG. 6. FIG. 6 is a flowchart showing the operations of the support person selection device according to the embodiment of the present invention. In the following description, FIGS. 1 to 5 will be referenced as appropriate. In this embodiment, the support person selection method is carried out by operating the support person selection device 10. Accordingly, the following description of the operations of the support person selection device 10 will replace a description of the support person selection method according to this embodiment.

It is presumed that a person who is to serve as a support person transmits the support person information to the support person selection device 10 and makes a request for registration of himself/herself via the support person terminal 20. Upon the support person information being registered in the support person information DB 18, an ID and a password are assigned to the support person from the support person selection device 10. Thereafter, each registered support person undergoes authentication and transmits his/her schedule via the support person terminal 20. The support person registration unit 14 thereby receives the schedule of each support person and registers the received schedule in the support person schedule DB 17 (see FIG. 3).

Initially, as shown in FIG. 6, upon the user transmitting the user conditions via the user terminal 30, the user registration unit 15 receives the user conditions and registers the received user conditions (step Al). The user conditions include the date on which a class (or a lecture) for which note-taking is to be carried out is to be held, the start time, the end time, the type of knowledge necessary for the class, the number of necessary support persons, the ID for specifying the user, and the class title.

Next, the support person candidate extraction unit 11 extracts support person candidates by comparing the schedule of each support person registered in the support person schedule DB 17 and the knowledge that each support person has registered in the support person information DB 18 with the user conditions (step A2). After executing step A2, the support person candidate extraction unit 11 outputs the IDs of the support persons who are the support person candidates and the user conditions to the most suitable support person selection unit 12.

Next, the most suitable support person selection unit 12 selects as many support persons as necessary from among the support person candidates based on the overall evaluation obtained from the numerical values indicating the grades of the respective items included in the evaluation information in order from a support person candidate with a best overall evaluation result (step A3). The most suitable support person selection unit 12 also outputs the ID of each selected support person to the e-mail transmission unit 16. Furthermore, the most suitable support person selection unit 12 accesses the support person schedule DB 17 and registers the schedules of the selected support person in the corresponding time period on the corresponding date having been filled.

Next, the e-mail transmission unit 16 acquires an e-mail address of each support person selected by the most suitable support person selection unit 12 from the support person information DB 18, and transmits, to this e-mail address, an e-mail indicating the user conditions and that the support person has been registered as a note-taker (step A4).

Thereafter, after the note-taking is carried out for the user who has registered user conditions in step Al by the support persons selected in step A3, the user transmits the evaluation of each support person to the support person selection device 10 via the user terminal 30. The evaluation information registration unit 13 thereby receives the evaluation, registers the received evaluation in the evaluation information DB 19, and executes updating or creation of the evaluation information (step A5).

Although steps A1 to A5 are shown as a series of processing in FIG. 6, it should be noted that this embodiment is not limited thereto. Step A5 may be executed independently of steps A1 to A4 every time a user makes evaluation. Steps A1 to A4 are executed every time a user registers the user conditions.

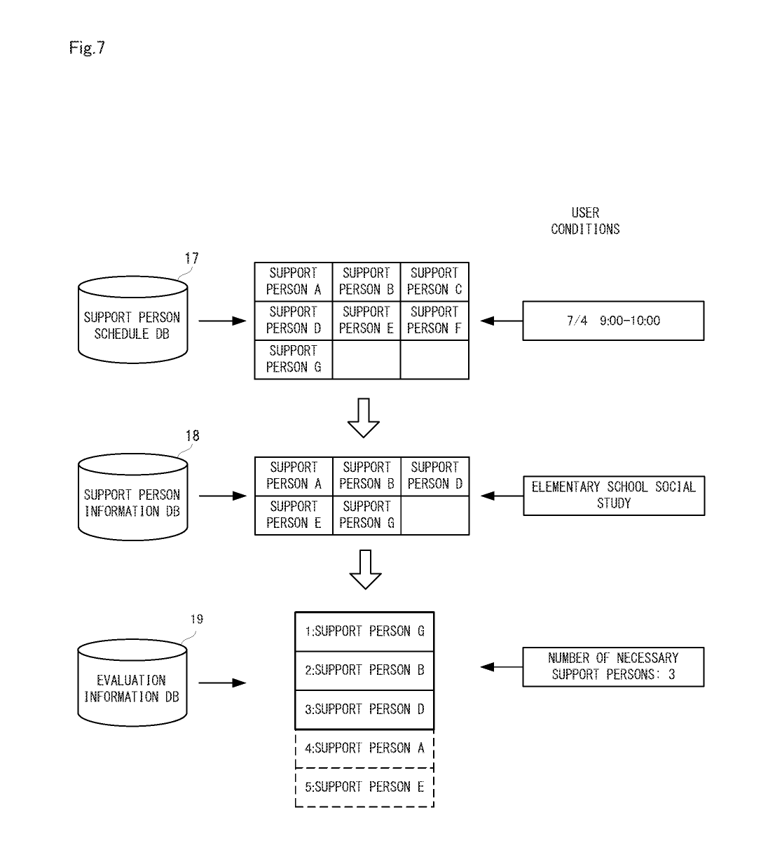

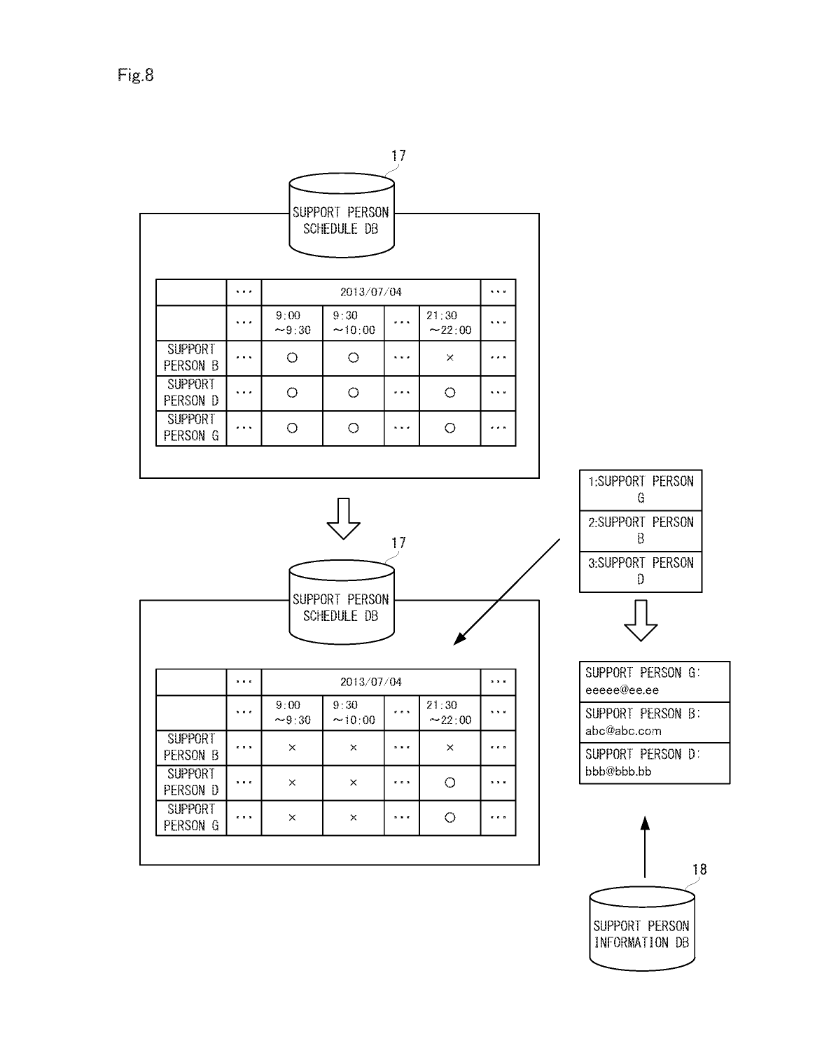

Here, a specific example of the processing in steps A1 to A4 shown in FIG. 6 will be described using FIGS. 7 and 8. FIG. 7 is a diagram illustrating a specific example of steps A1 to A3 shown in FIG. 6. FIG. 8 is a diagram illustrating a specific example of steps A3 and A4 shown in FIG. 6.

As shown in FIG. 7, it is assumed that the user conditions registered in step A1 include July 4, 9:00 to 10:00, elementary school social study, and three persons. In this case, in step A2, the support person candidate extraction unit 11 compares the schedule of each support person shown in FIG. 3 with the user conditions, and initially extracts support persons A to G whose schedules are available from 9:00 to 10:00 on July 4.

Next, the support person candidate extraction unit 11 compares subjects for which each support person can provide support shown in FIG. 4 with the user conditions, and extracts, from the support persons A to G, the support persons A, B, D, E, and G who have knowledge of elementary school social study as the support person candidates.

Next, the most suitable support person selection unit 12 references the evaluation information about each support person candidate shown in FIG. 5, and rearranges the support person candidates in order from a support person candidate with a highest overall evaluation. The support person candidates are thereby rearranged in order of G, B, D, A, and E as shown in FIG. 7. Then, the most suitable support person selection unit 12 selects three support persons, the number of which is defined in the user information, in order from a support person candidate with a highest overall evaluation. As a result, the top three persons, who are the support persons G, B, and D, are selected.

Thereafter, since the schedules of the selected three support persons are accordingly filled, the most suitable support person selection unit 5 accesses the support person schedule DB 17 and corrects “O” shown in boxes of 9:00 to 10:00 on July 4 for these three support persons as “X, as shown in FIG. 8.

Next, as shown in FIG. 8, the e-mail transmission unit 16 references the support person information DB 18 and extracts the e-mail addresses corresponding to the IDs of the three support persons based on the IDs of the three selected support persons. The e-mail transmission unit 16 then transmits an e-mail to the extracted e-mail addresses.

Thus, with the support person selection device 10 shown in FIG. 2, the schedule is adjusted between support persons and a user, and a team is automatically formed. Accordingly, the user can receive appropriate support. Furthermore, the user evaluation is also reflected in this team-forming, and as a result, understandability of the user is expected to improve.

[Program]

A program according to this embodiment need only be a program that causes a computer to execute steps A1 to A5 shown in FIG. 6. The support person selection device 10 and the support person selection method according to this embodiment can be achieved by installing this program in the computer and executing the program. In this case, a CPU (Central Processing Unit) of the computer performs processing while functioning as the support person candidate extraction unit 11, the most suitable support person selection unit 12, the evaluation information registration unit 13, the support person registration unit 14, the user registration unit 15, and the e-mail transmission unit 16.

In this embodiment, the support person schedule DB 17, the support person information DB 18, and the evaluation information DB 19 can be achieved by a storage device such as a hard disk provided in the computer, or other computers connected to that computer.

[Modifications]

This embodiment is not limited to the above-described example. For example, this embodiment may employ a mode in which the support person registration unit 14, the support person schedule DB 17, and the support person information DB 18 are constructed by a server computer other than the support person selection device 10. In this mode, the server computer can function as an external scheduler for each support person, and can manage the schedule of each support person.

In the case of employing the above mode, the support person selection device 10 does not need to include the e-mail transmission unit 16, and the most suitable support person selection unit 12 notifies the aforementioned server computer of the IDs of the selected support persons. In this case, the selected support persons are notified of the user conditions and that they have been registered as note-takers, by the server computer.

[Physical Configuration]

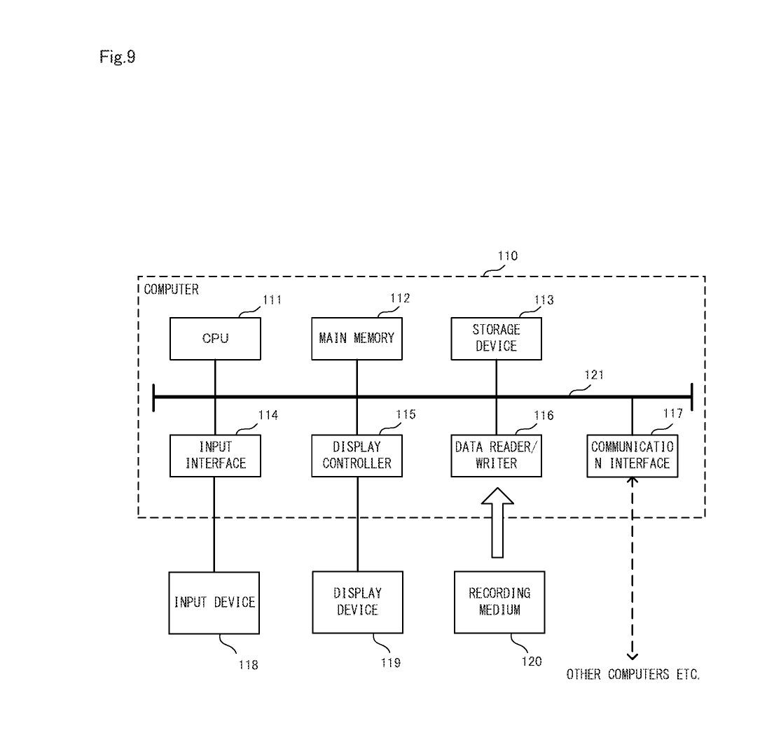

Here, the computer that achieves the support person selection device 10 by executing the program according to this embodiment will be described using FIG. 9. FIG. 9 is a block diagram showing an exemplary computer that achieves the support person selection device according to an embodiment of the present invention.

As shown in FIG. 9, the computer 110 includes a CPU 111, a main memory 112, a storage device 113, an input interface 114, a display controller 115, a data reader/writer 116, and a communication interface 117. These parts are connected to one another via a bus 121 such that data communication can be performed thereamong.

The CPU 111 carries out various calculations by deploying, in the main memory 112, the program (codes) according to this embodiment stored in the storage device 113, and executing these codes in predetermined order. The main memory 112 typically is a volatile storage device such as a DRAM (Dynamic Random Access Memory). The program according to this embodiment is provided in a state of being stored in a computer-readable recording medium 120. Note that the program according to this embodiment may be distributed on the Internet connected via the communication interface 117.

Specific examples of the storage device 113 include a semiconductor storage device such as a flash memory, as well as a hard disk. The input interface 114 mediates data transmission between the CPU 111 and the input device 118 such as a keyboard or a mouse. The display controller 115 is connected to the display device 119 and controls a display on the display device 119.

The data reader/writer 116 mediates data transmission between the CPU 111 and the recording medium 120, reads out the program from the recording medium 120, and executes writing of a result of processing performed by the computer 110 into the recording medium 120. The communication interface 117 mediates data transmission between the CPU 111 and other computers.

Specific examples of the recording medium 120 include a general-purpose semiconductor device such as a CF (Compact Flash (registered trademark) or an SD (Secure Digital), a magnetic recording medium such as a flexible disk, or an optical recording medium such as a CD-ROM (Compact Disk Read Only Memory).

A part or all of the above-described embodiment can be expressed by Supplementary note 1 to Supplementary note 18 that will be described below, but is not limited to the following description.

Supplementary Note 1

A support person selection device for selecting a support person who is to provide support that a user seeks, comprising:

a support person candidate extraction unit for extracting at least one support person candidate who can provide the support that the user seeks, based on a schedule of the support person which is registered in advance and a condition that the user seeks;

a most suitable support person selection unit for selecting, from the at least one extracted support person candidate, a support person to whom a request for the support is to be made, based on evaluation information associated with each support person; and

an evaluation information registration unit for receiving evaluation made by the user who has received the support from the selected support person, and updating the evaluation information associated with the selected support person or creating new evaluation information.

Supplementary N 2

The support person selection device according to Supplementary note 1,

wherein the support is note-taking for a person with hearing impairment, and the support person is a note-taker.

Supplementary Note 3

The support person selection device according to Supplementary note 2,

wherein the evaluation made by the user is expressed by a numerical value indicating a grade of each of items that are an accuracy of note-taking input, an input speed, understandability of a summary note, and impression of the support person who has provided the support, and

the evaluation information includes the numerical value indicating the grade of each of the items.

Supplementary Note 4

The support person selection device according to Supplementary note 3,

wherein the most suitable support person selection unit selects as many support persons as necessary based on an overall evaluation obtained from the numerical value indicating the grade of each of the items included in the evaluation information in order from the support person candidate with a best overall evaluation result.

Supplementary Note 5

The support person selection device according to Supplementary note 2,

wherein knowledge that the support person has is registered in addition to the schedule of the support person,

the condition that the user seeks includes a date on which a lecture or a class for which note-taking is to be carried out is held, a start time, an end time, a type of necessary knowledge, and the number of necessary support persons, and

the support person candidate extraction unit extracts the support person candidate by comparing the schedule and the knowledge of the support person with the condition that the user seeks.

Supplementary Note 6

The support person selection device according to Supplementary note 1, further comprising:

an e-mail transmission unit for transmitting, to the support person selected by the most suitable support person selection unit, an e-mail for making a request for the support that the user seeks.

Supplementary Note 7

A support person selection method for selecting a support person who is to provide support that a user seeks, the method comprising:

a step (a) of extracting at least one support person candidate who can provide the support that the user seeks, based on a schedule of the support person which is registered in advance and a condition that the user seeks;

a step (b) of selecting, from the at least one extracted support person candidate, a support person to whom a request for the support is to be made, based on evaluation information associated with each support person; and

a step (c) of receiving evaluation made by the user who has received the support from the selected support person, and updating the evaluation information associated with the selected support person or creating new evaluation information.

Supplementary Note 8

The support person selection method according to Supplementary note 7,

wherein the support is note-taking for a person with hearing impairment, and the support person is a note-taker.

Supplementary Note 9

The support person selection method according to Supplementary note 8,

wherein the evaluation made by the user is expressed by a numerical value indicating a grade of each of items that are an accuracy of note-taking input, an input speed, understandability of a summary note, and impression of the support person who has provided the support, and

the evaluation information includes the numerical value indicating the grade of each of the items.

Supplementary Note 10

The support person selection method according to Supplementary note 9,

wherein in step (b), as many support persons as necessary are selected based on an overall evaluation obtained from the numerical value indicating the grade of each of the items included in the evaluation information in order from the support person candidate with a best overall evaluation result.

Supplementary Note 11

The support person selection method according to Supplementary note 8,

wherein knowledge that the support person has is registered in addition to the schedule of the support person,

the condition that the user seeks includes a date on which a lecture or a class for which note-taking is to be carried out is held, a start time, an end time, a type of necessary knowledge, and the number of necessary support persons, and

in step (a), the support person candidate is extracted by comparing the schedule and the knowledge of the support person with the condition that the user seeks.

Supplementary Note 12

The support person selection method according to Supplementary note 7, further including:

a step (d) of transmitting, to the support person selected in the step (c), an e-mail for making a request for the support that the user seeks.

Supplementary Note 13

A computer-readable recording medium that stores a program for selecting a support person who is to provide support that a user seeks, by a computer, the recording medium storing a program including a command for causing the computer to execute:

a step (a) of extracting at least one support person candidate who can provide the support that the user seeks, based on a schedule of the support person which is registered in advance and a condition that the user seeks;

a step (b) of selecting, from the at least one extracted support person candidate, a support person to whom a request for the support is to be made, based on evaluation information associated with each support person; and

a step (c) of receiving evaluation made by the user who has received the support from the selected support person, and updating the evaluation information associated with the selected support person or creating new evaluation information.

Supplementary Note 14

The computer-readable recording medium according to Supplementary note 13,

wherein the support is note-taking for a person with hearing impairment, and the support person is a note-taker.

Supplementary Note 15

The computer-readable recording medium according to Supplementary note 14,

wherein the evaluation made by the user is expressed by a numerical value indicating a grade of each of items that are an accuracy of note-taking input, an input speed, understandability of a summary note, and impression of the support person who has provided the support, and

the evaluation information includes the numerical value indicating the grade of each of the items.

Supplementary Note 16

The computer-readable recording medium according to Supplementary note 15,

wherein in step (b), as many support persons as necessary are selected based on an overall evaluation obtained from the numerical value indicating the grade of each of the items included in the evaluation information in order from the support person candidate with a best overall evaluation result.

Supplementary Note 17

The computer-readable recording medium according to Supplementary note 14,

wherein knowledge that the support person has is registered in addition to the schedule of the support person,

the condition that the user seeks includes a date on which a lecture or a class for which note-taking is to be carried out is held, a start time, an end time, a type of necessary knowledge, and the number of necessary support persons, and

in step (a), the support person candidate is extracted by comparing the schedule and the knowledge of the support person with the condition that the user seeks.

Supplementary Note 18

The computer-readable recording medium according to Supplementary note 13, further including:

a step (d) of transmitting, to the support person selected in the step (c), an e-mail for making a request for the support that the user seeks.

The invention in the present application has been described with reference to the embodiment, but the invention in the present application is not limited to the above-described embodiment. The configurations and details of the invention in the present application may be subjected to various modifications that could be understood by those skilled in the art within the scope of the invention in the present application.

This application claims the benefit of priority based on Japanese Patent Application 2013-239083 filed on Nov. 19, 2013, the entire disclosure of which is hereby incorporated herein by reference.

### INDUSTRIAL APPLICABILITY

As described above, according to the present invention, it is possible to deal with short-term support and reflect a user evaluation in selection of a support person who is to provide support to the user. The present invention is useful particularly in the case where a person with hearing impairment seeks note-taking as support.

### REFERENCE SIGNS LIST

10 Support person selection device

11 Support person candidate extraction unit

12 Most suitable support person selection unit

13 Evaluation information registration unit

14 Support person registration unit

15 User registration unit

16 E-mail transmission unit

17 Support person schedule DB

18 Support person information DB

19 Evaluation information DB

20 Support person terminal

30 User terminal

110 Computer

111 CPU

112 Main memory

113 Storage device

114 Input interface

115 Display controller

116 Data reader/writer

117 Communication interface

118 Input device

119 Display device

120 Recording medium

121 Bus

1. A support person selection device for selecting a support person who is to provide support that a user seeks, comprising:
a support person candidate extraction unit for extracting at least one support person candidate who can provide the support that the user seeks, based on a schedule of the support person which is registered in advance and a condition that the user seeks;
a most suitable support person selection unit for selecting, from the at least one extracted support person candidate, a support person to whom a request for the support is to be made, based on evaluation information associated with each support person; and
an evaluation information registration unit for receiving evaluation made by the user who has received the support from the selected support person, and updating the evaluation information associated with the selected support person or creating new evaluation information.

2. The support person selection device according to claim 1,
wherein the support is note-taking for a person with hearing impairment, and the support person is a note-taker.

3. The support person selection device according to claim 2,
wherein the evaluation made by the user is expressed by a numerical value indicating a grade of each of items that are an accuracy of note-taking input, an input speed, understandability of a summary note, and impression of the support person who has provided the support, and
the evaluation information includes the numerical value indicating the grade of each of the items.

4. The support person selection device according to claim 3,
wherein the most suitable support person selection unit selects as many support persons as necessary based on an overall evaluation obtained from the numerical value indicating the grade of each of the items included in the evaluation information in order from the support person candidate with a best overall evaluation result.

5. The support person selection device according to claim 2,
wherein knowledge that the support person has is registered in addition to the schedule of the support person,
the condition that the user seeks includes a date on which a lecture or a class for which note-taking is to be carried out is held, a start time, an end time, a type of necessary knowledge, and the number of necessary support persons, and
the support person candidate extraction unit extracts the support person candidate by comparing the schedule and the knowledge of the support person with the condition that the user seeks.

6. The support person selection device according to claim 1, further comprising
an e-mail transmission unit for transmitting, to the support person selected by the most suitable support person selection unit, an e-mail for making a request for the support that the user seeks.

7. A support person selection method for selecting a support person who is to provide support that a user seeks, the method comprising:
a step (a) of extracting at least one support person candidate who can provide the support that the user seeks, based on a schedule of the support person which is registered in advance and a condition that the user seeks;
a step (b) of selecting, from the at least one extracted support person candidate, a support person to whom a request for the support is to be made, based on evaluation information associated with each support person; and
a step (c) of receiving evaluation made by the user who has received the support from the selected support person, and updating the evaluation information associated with the selected support person or creating new evaluation information.

8. A non-transitory computer-readable recording medium that stores a program for selecting a support person who is to provide support that a user seeks, by a computer, the recording medium storing a program including a command for causing the computer to execute:
a step (a) of extracting at least one support person candidate who can provide the support that the user seeks, based on a schedule of the support person which is registered in advance and a condition that the user seeks;
a step (b) of selecting, from the at least one extracted support person candidate, a support person to whom a request for the support is to be made, based on evaluation information associated with each support person; and
a step (c) of receiving evaluation made by the user who has received the support from the selected support person, and updating the evaluation information associated with the selected support person or creating new evaluation information.
